(19) United States
(12) Patent Application Publication
(10) Pub. No.: US 2012/0126494 A1
(43) Pub. Date: May 24, 2012

(54) PNEUMATIC CLAMPING CYLINDER

(76) Inventor: Helmut Weichler, Bachhagel (DE)

(21) Appl. No.: 13/265,233

(22) PCT Filed: Jun. 10, 2010
(86) PCT No.: PCT/DE10/75049

§ 371 Date: Nov. 15, 2011

(30) Foreign Application Priority Data
Jul. 7, 2009 (DE) 10 2009 026 118.4

(51) Int. Cl. B23B 31/30

(52) U.S. Cl. 279/4.04

(57) ABSTRACT

The invention relates to a pneumatic clamping cylinder (1) for clamping devices on machine tools (2), comprising a cylinder housing (3) that can be coupled to the rotationally drivable working spindle of the machine tool (2) and a cylinder piston (6) that can be axially moved in the cylinder chamber (5) of the cylinder housing (3). A first annular bearing element (11) is arranged between the cylinder piston (6) and the cylinder housing (3) as a bearing, and a second annular bearing element (12) is arranged between the cylinder piston (6) and the working spindle (4) as a bearing, wherein both the first annular bearing element (11) and the second annular bearing element (12) are designed to have a minimum play of 1/100 mm.

The invention relates to a pneumatic actuating cylinder for a workpiece holder of a machining apparatus. In particular, it relates to a pneumatic actuating cylinder for a workpiece holder comprising a cylindrical housing connectable to the rotationally driven working spindle of the machining apparatus, and comprising a cylindrical piston that is axially movable in a cylindrical chamber of the cylindrical housing, which piston can be shifted in the chamber by varying air pressure between cylinder chambers.

In order to ensure the desired service life for the actuating cylinder when in continuous operation, the operation of conventional a pneumatic actuating cylinder for a workpiece holder requires that lubricants be added continuously to the compressed air used as pressurizing means. However, this addition of lubricants to the compressed air first of all results in a contamination of the exhaust air with residual lubricant, and second necessitates a relatively complex design for the pneumatic actuating cylinder.

The object of this invention is to overcome the above-referenced disadvantages found in the conventional actuating cylinders and to provide a pneumatic actuating cylinder that can be operated precisely and on a long-term basis without the addition of lubricants.

In a pneumatic actuating cylinder for a workpiece holder of a machining apparatus, comprising a cylindrical housing connectable to the rotationally driven working spindle of the machining apparatus, a cylindrical piston axially movable in a cylindrical chamber of the housing, and a first annular bearing element bearing between the piston and the housing, and a second annular bearing element between the piston and the working spindle, this object is achieved by designing both the first annular bearing element as well as the second annular bearing element so as to have a play of at least 1/100 mm. This design has the advantage that the operation of the actuating cylinder can be ensured due to the enhanced play, with the result that less stringent requirements are sufficient in terms of the lubrication.

The first annular bearing element is preferably provided on an inner surface of the housing between the piston and the housing, while the second annular bearing element is provided on the inner surface of the working spindle between the piston and the working spindle, thereby achieving increased stability.

It has been found advantageous to provide a first sealing element on an outer surface of the cylindrical housing between the piston and the housing, and to provide a second sealing element on the outer surface of the housing between the piston and the working spindle. This design has the advantage of being able to achieve an especially effective seal, the interaction of the minimum play and improved seal in particular resulting in an increased service life of the pneumatic actuating cylinder while effectively preventing piston seizure.

In addition, a third sealing element can be provided between the piston collar and the housing. It has been found especially advantageous in this connection for the third sealing element to include a first sealing part and a second sealing part that are set at a predetermined spacing, thereby enabling an improved stability and seal to be achieved.

In an advantageous embodiment of the pneumatic actuating cylinder, the first sealing element and/or the second sealing element and/or the third sealing element include cavities holding lubricants, with the result that lubricants can be automatically dispensed in very small amounts over the life of the sealing elements.

It has been found advantageous for the first sealing element and/or the second sealing element and/or the third sealing element to be composed of polyurethane. It has furthermore been found advantageous for the first annular bearing element and/or the second annular bearing element to be composed of polyethylene.

The following describes the invention in more detail based on embodiments illustrated in the drawings. Therein:

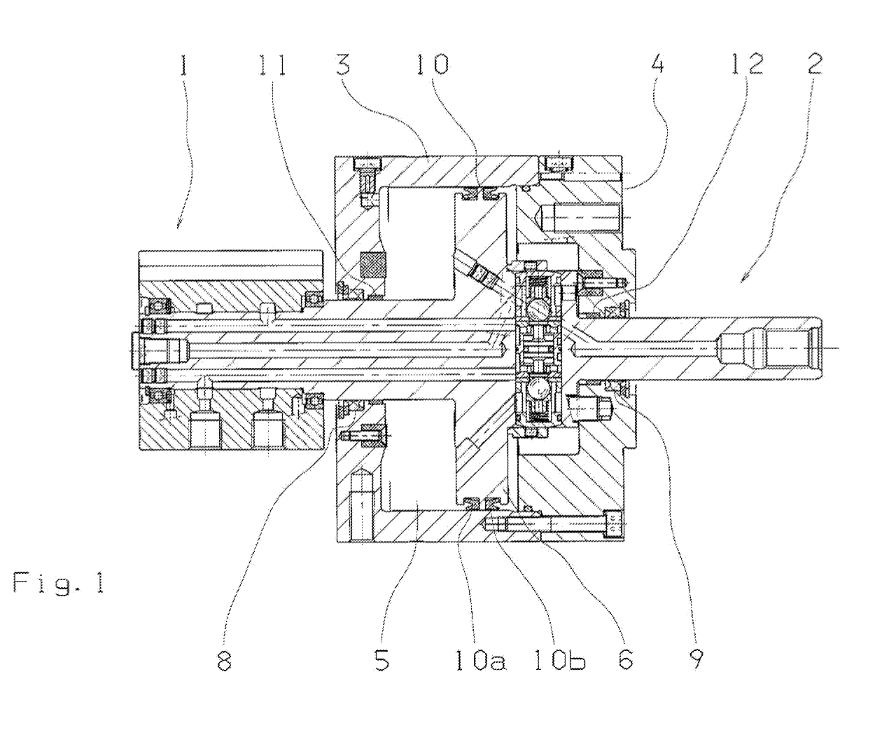

FIG. 1 is a schematic cross section through a first embodiment of a pneumatic actuating cylinder;

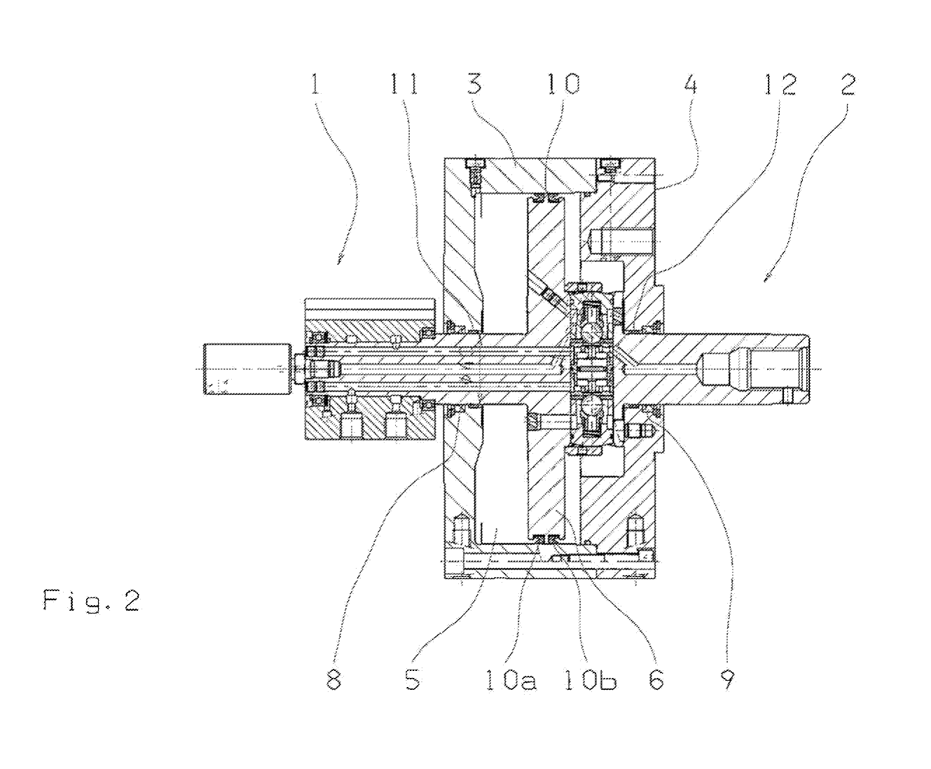

FIG. 2 is a schematic cross section through a second embodiment of the pneumatic actuating cylinder; and

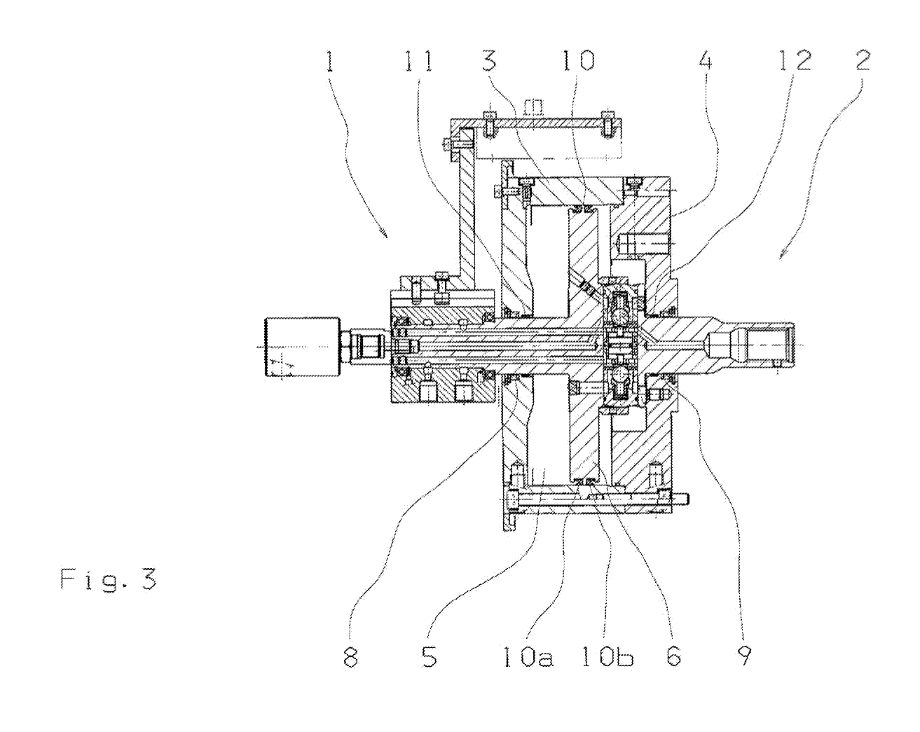

FIG. 3 is a schematic cross sectional through a third embodiment of the actuating cylinder.

FIGS. 1 through 3 are schematic cross sections illustrating different embodiments of pneumatic actuating cylinders 1 according to this invention. The cylinder 1 actuates a workpiece holder of a machining apparatus 2, the workpiece holders themselves not being shown in the drawings, to which end the actuating cylinder 1 has a cylindrical housing 3 connectable to a rotationally driven working spindle 4 of the apparatus 2. An axially movable cylindrical piston 6 can move in the housing 3 in a cylindrical chamber 5, which piston can be shifted in the chamber 5 by the application of compressed air in pressurizable chambers. A first annular bearing element 11 is provided between the piston 6 and the housing 3, and a second annular bearing element 12 between the piston 6 and the working spindle 4, the first annular bearing element 11 being mounted on an inner surface of the housing 3 between the piston 6 and the housing 3, the second annular bearing element 12 being mounted on an inner surface of the working spindle 4 between the piston 6 and the working spindle 4.

A first sealing element 8 is provided on an outer surface of the housing 3 between the piston 6 and the housing 3, while a second sealing element 9 is provided on the outer surface of working spindle 4 between the piston 6 and working spindle 4. In addition, a third sealing element 10 can be provided between a piston collar and the housing 3.

### List of reference numerals

1 actuating cylinder
2 machining apparatus
3 cylindrical housing
4 working spindle
5 cylindrical chamber
6 axially slidable cylindrical piston
8 first sealing element
9 second sealing element
10 third sealing element
10a first sealing part
10b second sealing part
11 first annular bearing element
12 second annular bearing element

1. A pneumatic actuating cylinder for a workpiece holder of a machining apparatus, the actuating cylinder comprising:
a cylindrical housing connectable to the rotationally driven working spindle of the machining apparatus,
a cylindrical piston axially movable in a cylindrical chamber of the housing, and
a first annular bearing element bearing between the piston and the housing and a second annular bearing element between the piston and the working spindle, both the first annular bearing element and also the second annular bearing element having a minimum play of 1/100 mm.

2. The pneumatic actuating cylinder according to claim 1, wherein the first annular bearing element is provided on an inner surface of the housing between the piston and the housing and that the second annular bearing element is provided on an inner surface of the working spindle between the piston and the working spindle.

3. The pneumatic actuating cylinder according to claim 2, wherein a first sealing element is provided on an outer surface of the housing between the piston and the housing and that a second sealing element is provided on the outer surface of the working spindle between the piston and the working spindle.

4. The pneumatic actuating cylinder according to claim 3, wherein a third sealing element is provided between a piston collar and the housing.

5. The pneumatic actuating cylinder according to claim 4, wherein the third sealing element comprises a first sealing part and a second sealing part that are set at a predetermined spacing.

6. The pneumatic actuating cylinder according to claim 3, wherein the first sealing element or the second sealing element or the third sealing element include cavities holding lubricants.

7. The pneumatic actuating cylinder according to claim 3, wherein the first sealing element or the second sealing element or the third sealing element are at least partially of polyurethane.

8. The pneumatic actuating cylinder according to claim 1, wherein the first annular bearing element or the second annular bearing element are at least partially of polyethylene.
